(19) United States
(12) Patent Application Publication
(10) Pub. No.: US 2008/0064278 A1
(43) Pub. Date: Mar. 13, 2008

(54) Wipes with indicia to indicate function

(76) Inventor: John R. Oaroche, Hong Kong (HK)

Correspondence Address: PATENTS+TMS, P.C., 2849 W. ARMITAGE AVE., CHICAGO, IL, 60647, US

(21) Appl. No.: 11/788,681

(22) Filed: Apr. 20, 2007

Related U.S. Application Data
(60) Provisional application No. 60/905,633, filed on Mar. 8, 2007.
(60) Provisional application No. 60/858,566, filed on Nov. 13, 2006.
(60) Provisional application No. 60/843,863, filed on Sep. 12, 2006.

(51) Int. Cl. B32B 3/00; B05D 1/36

(52) U.S. Cl. 442/59; 427/402; 428/221

(57) ABSTRACT

A system and a method for identifying disposable wipes are provided. Indicia, such as scent, color coding and/or icon identification on the wipes, assist the user in identifying the categorization of the wipes. The indicia are printed on the top and bottom sides of each of the wipes. A color coded icon indicates an intended use of an uploaded wipe and/or a location of common use. In addition, the color coded icon and/or the scent of each of the types of the wipes provides a functional notification ensuring that a user does not confuse one of the types of wipes with other types of wipes. Thus, dispensers may be stacked together and/or multiple wipes may be used in the same area. Various combinations of functional wipes may be easily implemented and/or customized to fit the needs of the user.

This application claims the benefit of U.S. Provisional Patent Application Ser. No. 60/905,633, filed on Mar. 8, 2007; U.S. Provisional Application Ser. No. 60/858,566, filed on Nov. 13, 2006; and U.S. Provisional Application Ser. No. 60/843,863, filed on Sep. 12, 2006.

### BACKGROUND OF THE INVENTION

The present invention generally relates to wipes with indicia to indicate function. The wipes allow a user to readily identify individual and a number of different types of pre-impregnated wipes, such as, for example, household, car, utility and personal cleaning wipes.

Cleaning, polishing, disinfecting, antibacterial, and/or protectant wipe products for household, car, utility and personal and pet care are common and include rolls or sheets of folded material which are sold in various types of packaging and counter-top disposable dispensers. A common form of wipes packaging is the plastic or foil envelope with a melded seal at both ends and a slot or opening in the middle of the envelope exposed and sealed using an adhesive flap. This re-sealable flap may utilize adhesive tape or, in its complex form, a plastic frame and door surrounding the opening.

Existing disposable counter top dispensers have various dispensing mechanisms with flip up tops or push button lids to keep wipes moist. However, none of these products are specifically designed to be optionally wall-mounted, incorporate an interlocking slide track mechanism locking a refill into the dispenser nor designed to facilitate a series of stacked dispensers. Furthermore, they do not allow for various wipe refill packages from different cleaning and personal care categories to be used quickly and interchangeably in the same reusable/semi-permanent dispenser.

No existing dispenser system provides a particular window to expose a refill label which allows the user to readily recognize the unique color-coded identifier for the specific use of the wipe. Current dispensing products in the market address only a single, specific container for that particular type of wipe. Additionally, wipes in the market are white colored, whether they are for baby wipes or windows or car leather.

Accordingly, there is a need for pre-impregnated household, car, utility and personal wipes in convenient locations, immediately available to users, that enable the functionality of the wipes to be easily identifiable (formulation, description and branding). The present invention is directed to overcoming one or more of the problems or disadvantages associated with the prior art.

### SUMMARY OF THE INVENTION

The present invention generally relates to a disposable wipe having a substrate made from an absorbent textile material, a functional utility compound impregnated into the substrate for enhancing the ability of the wipe to perform a predetermined task, and indicia applied to the substrate for indicating the predetermined task. The absorbent textile material may be a non-woven material or a paper material, and the indicia applied to the substrate may include a fragrance and/or an imprinted icon. The imprinted icon may include a pictorial symbol and/or a color-coded symbol to indicate functional use and/or location of common use to a wipes user. The imprinted icon may include a logo, title, photograph and/or brand to convey a message and/or sensation to the wipes user.

According to another aspect of the invention, a system dispensing a number of different pre-impregnated household, car, utility and personal and pet care wipes for cleaning, polishing, disinfecting, eliminating bacteria and/or protecting has at least one wipe dispensing module and a plurality of types of pre-impregnated wipes. Indicia is applied to each wipe that corresponds with a functional utility performed by the wipe based on a formulated solution that is impregnated into the wipe.

In an embodiment of the present invention, a disposable wipe is provided. The disposable wipe has a substrate made from an absorbent textile material wherein the substrate has a top side and a bottom side wherein the bottom side is positioned opposite to the top side; a formulated utility solution impregnated into the substrate; and colored graphic indicia applied in aqueous ink to the top side of the substrate and the bottom side of the substrate that indicates the formulated utility solution impregnated into the substrate.

In an embodiment, the absorbent textile material is a non-woven material.

In an embodiment, the disposable wipe has a fragrance applied to the substrate wherein the fragrance is a representation of an intended use of the formulated utility solution.

In an embodiment, the colored graphic indicia are representations of an intended use of the formulated utility solution.

In an embodiment, the colored graphic indicia denote a location where the substrate is intended to be commonly used.

In an embodiment, the colored graphic indicia are brand logos that correspond to a manufacturer of the substrate.

In another embodiment, a system for providing pre-impregnated cleaning, disinfecting, antibacterial, polishing, protectant wipes wherein the wipes are impregnated for any one of a plurality of intended uses is provided. The system has a formulated solution having one of the plurality of intended uses; a first set of substrates wherein the formulated solution is impregnated into each of the set of substrates wherein each of the first set of substrates has a first side and a second side wherein the second side is positioned opposite to the first side; and colored indicia imprinted in aqueous ink on the first side and the second side of each of the first set of substrates wherein the colored indicia indicate one of the plurality of intended uses of the formulated solution.

In an embodiment, the colored indicia denote a location where the first set of substrates is intended to be commonly used.

In an embodiment, the indicia indicate a shape of each of the first set of substrates.

In an embodiment, the indicia indicate a size of each of the first set of substrates.

In an embodiment, the system has a fragrance associated with the first set of substrates wherein the fragrance corresponds to one of the plurality of intended uses of the set of substrates.

In an embodiment, the first set of substrates are made from absorbent material.

In an embodiment, the first set of substrates are made from paper material.

In an embodiment, the system has a second set of the substrates wherein colored indicia are imprinted in aqueous ink on the second set of substrates wherein the colored indicia printed on the second set of substrates are different than the colored indicia imprinted on the first set of substrates.

In another embodiment, a method for providing wipes is provided. The method comprises the steps of: providing a first set of substrates wherein the first set of substrates has a function; applying a formulated solution to the first set of substrates to effectuate the function of the first set of substrates; imprinting colored indicia on a top side and a back side of each of the first set of substrates wherein the back side is positioned opposite to the top side wherein the colored indicia identify the function of the first set of substrates.

In an embodiment, the colored indicia indicate a location where the first set of substrates is intended to be commonly used.

In an embodiment, the colored indicia are representations of an intended use of the formulated solution.

In an embodiment, a method for providing wipes is provided further comprising the step of: associating a fragrance with the first set of substrates wherein the fragrance indicates the function of the first set of substrates.

In an embodiment, a method for providing wipes is provided further comprising the step of: providing a second set of substrates wherein colored indicia are imprinted in aqueous ink on the second set of substrates wherein the colored indicia imprinted on the second set of substrates are different than the colored indicia imprinted on the first set of substrates wherein the colored indicia printed on the second set of substrates identify a function of the second set of substrates wherein the function of the first set of substrates is different than the function of the second set of substrates.

In an embodiment, the colored indicia indicate a size of the wipe.

In an embodiment, the colored indicia indicate a shape of the wipe.

It is, therefore, an advantage of the present invention to provide wipes with indicia that indicate functional utility and a method for dispensing wipes with indicia that indicate functional utility.

Another advantage of the present invention is to provide wipes with indicia and a method for dispensing wipes with indicia that convey a message and/or sensation to the user.

Another advantage of the present invention is to provide wipes and a method for dispensing wipes with indicia in a manner that indicates the functional utility of a dispensed wipe to differentiate the dispensed wipe from wipes with other functional utilities indicated by different indicia.

Yet another advantage of the present invention is to provide wipes and a method for dispensing wipes that have colors that differentiate different intended use locations of the wipes.

Further, an advantage of the present invention is to provide wipes and a method for dispensing wipes that have icons that differentiate intended uses of different wipes.

Still further, an advantage of the present invention is to provide wipes and a method for dispensing wipes that have scents that differentiate different intended uses of the wipes.

Still further, an advantage of the present invention is to provide wipes and a method of dispensing wipes that have logos, titles, photographs or brands that convey a message or evoke particular sensations from the user.

Moreover, an advantage of the present invention is to provide different types of wipes that may be provided adjacent to each other without confusion by a user as to an intended use of a dispensed wipe.

Additional features and advantages of the present invention are described in, and will be apparent from, the detailed description of the presently preferred embodiments and from the drawings.

### BRIEF DESCRIPTION OF THE DRAWINGS

FIG. 1 is a perspective view of a wipes dispensing module in various configurations in an embodiment of the invention.

FIG. 2 is a perspective view of a wipes dispensing module and a cartridge in an embodiment of the invention.

FIG. 3 is a perspective view of a cartridge in an embodiment of the invention.

FIG. 4 is a perspective view of a wipes dispensing module in an embodiment of the invention.

FIG. 5 is a perspective view of a wipes dispensing module and a cartridge according to another embodiment of the invention.

FIG. 6 is a table showing icons, as indicia, that may be printed on wipes to identify an intended use for each wipe in an embodiment of the invention.

FIG. 7 is a depiction of wipes that may be color coded and/or imprinted with icons, as indicia, to identify an intended use for the wipes in an embodiment of the invention.

FIG. 8 is a diagrammatic depiction of wipes that may be color coded and/or printed with icons, as indicia, to identify an intended use for the wipes in an embodiment of the invention.

### DETAILED DESCRIPTION OF THE PRESENTLY PREFERRED EMBODIMENTS

The present invention generally relates to pre-impregnated household, utility and personal cleaning wipes and a method for dispensing same. More specifically, the present invention relates to wipes having indicia, such as, for example, a graphic icon, a color and/or a fragrance that indicates function.

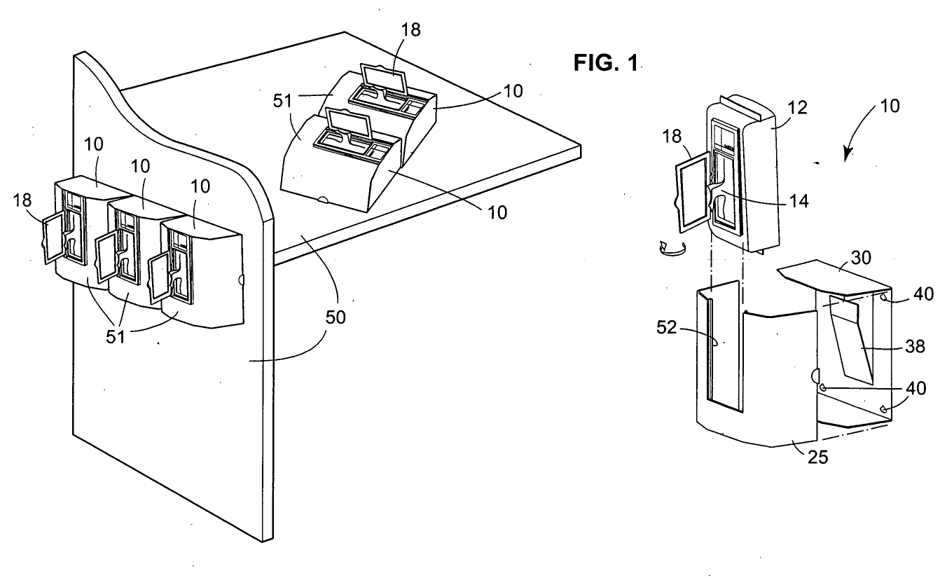

Referring to FIG. 1, the wipes dispensing system may have at least one wipes dispensing module 10. Multiple wipes dispensing modules 10 may be mounted in a linked manner. The wipes dispensing module 10 may be affixed to a surface 50, such as, for example, an inner surface of a door of a cabinet, a closet and/or a pantry, or may be installed on a flat surface and/or a wall of a high usage area such as, for example, a baby room, a kitchen, a workshop and/or a garage. The wipes dispensing module 10 may be affixed in a conventional manner using connecting means, such as, for example, screws and/or adhesive pads. The wipes dispensing module 10 may be affixed by connection with a mounting plate or may be connected directly to the flat surface. The mounting plate may accommodate several other dispensers. The connecting means may enable the wipes dispensing module 10 to be positioned as desired.

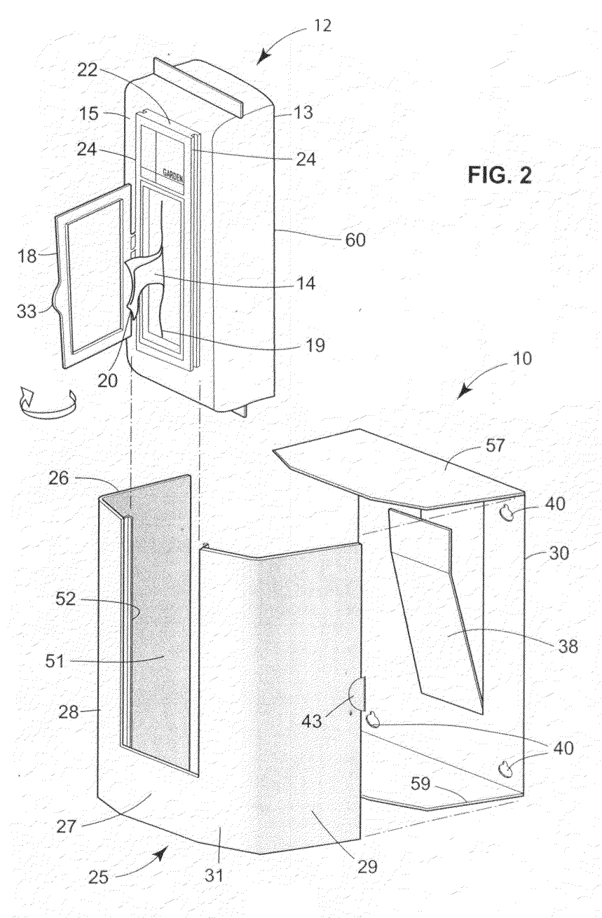

As generally shown in FIG. 2, the wipes dispensing module 10 may be designed to accommodate a cartridge 12. The cartridge 12 may contain wipes 14 for an intended use, such as, for example, window cleaning, multi-surface cleaning, car cleaning, antibacterial sanitization, grease/paint/heavy stains cleaning, a specific material for polishing/protecting (leather/furniture) and/or other personal cleaning situations. The cartridge 12 may have a back side 13 and/or a front side 15 wherein the front side 15 may be positioned opposite to the back side 13. The wipes 14 may be made from a material such as a non-woven paper sheet impregnated with formulated personal care, cleaning, polishing and/or protective solutions.

The wipes 14 may be folded into a plastic or foil package 60 and/or may be sealed with a protective adhesive seal (not shown) that may remain sealed until opened. Once opened by pulling back the protective adhesive seal, an opening 19 in the cartridge 12 may be revealed through which the wipes 14 may be accessed. A door 18 may be attached to the cartridge 12. The door 18 may be closed over the opening 19 after one of the wipes 14 is dispensed. The door 18 on the front side 15 of the cartridge 12 may be opened to provide access to a leading end portion 20 of one of the wipes 14 within the cartridge 12. A user may pull the leading end portion 20 of one of the wipes 14 within the cartridge 12 to dispense one of the wipes 14 from the wipes dispensing module 10. Further, the door 18 may close to seal the cartridge 12 and/or to keep the wipes 14 moist. The door 18 may be manufactured from plastic or other like material.

The cartridge 12 may have a plastic frame with tracks 24 to permit the cartridge 12 to attach into the front cover 25 when positioned vertically. A raised portion 22 of the cartridge 12 that may have the door 18, the protective adhesive seal and/or the opening 19 of the cartridge 12 may extend from the front side 15 of the cartridge 12. Extension of the raised portion 22 from the front side 15 of the cartridge 12 may form the tracks 24. The raised portion 22 of the cartridge 12 may have a perimeter, and the tracks 24 may extend from the perimeter of the raised portion 22 of the cartridge 12.

The wipes dispensing module 10 may be rectangular in shape and/or may be formed from a front cover 25 and a back mounting shell 30. The front cover 25 and/or the back mounting shell 30 may be manufactured from molded plastic, such as, for example, ABS, PS, PP, and/or HIPS. The dispensing module 10 may be manufactured from stainless steel, acrylic and/or other like materials.

The front cover 25 may have a front planar surface 27 and/or side walls extending from the front planar surface 27. The front planar surface 27 may have a left side and a right side that may be positioned opposite to the left side. A left wall 26 may be connected to the left side of the front planar surface and/or a right wall 29 may be connected to the right side of the front planar surface. The left wall 26 and the right wall 29 may be generally parallel. Alternatively, the left wall 26 and the right wall 29 may taper toward the front planar surface so that the left wall 26 and the right wall 29 may not be generally parallel. In a preferred embodiment, the left wall 26 and the right wall 29 may be parallel, and the front cover 25 may have a left tapered portion 28 and/or a right tapered portion 31 that connect the left wall 26 and/or the right wall 29 to the planar front surface, respectively.

The front cover 25 may have a generally U-shaped opening 51 on the front planar surface 27. The U-shaped opening 51 may have a size and a shape such that the size and the shape of the U-shaped opening 51 may be generally the same as a size and a shape of the raised portion 22 of the cartridge 12. As generally shown in FIG. 2, the tracks 24 of the cartridge 12 may allow the cartridge 12 to connect to projections 52 from the front cover 25 of the wipes dispensing module 10. The size and the shape of the U-shaped opening 51 may allow the raised portion 22 of the cartridge 12 to fit within the U-shaped opening 51. The tracks 24 may be any type of rails and/or grooves that allow the projections 52 from the front cover 25 to insert into the tracks 24 to connect the cartridge 12 to the front cover 25. Thus, the cartridge 12 may be positioned so that edges of the U-shaped opening 51 in the front cover 25 may insert into the tracks 24 on the cartridge 12. Insertion of the edges of the U-shaped opening 51 into the tracks 24 on the cartridge 12 may allow the cartridge 12 to attach to the front cover 25 so that connecting the front cover 25 to the back mounting shell 30 forms the wipes dispensing module 10 as shown in FIGS. 1 and 2.

The front cover 25 may have any form of the projections 52 that may be inserted into the tracks 24 of the cartridge 12. Alternatively, tracks on the front cover 25 and projections on the cartridge 12 may connect the cartridge 12 to the front cover 25. The cartridge 12 may connect to the front cover 25 by any generally known connecting means.

Connection of the cartridge 12 to the front cover may align the opening 19 of the cartridge 12 with the U-shaped opening 51 of the front cover 25. Connection of the U-shaped opening 51 on the front cover 25 to the tracks 24 of the cartridge 12 may be used in other applications in addition to the wipes dispensing module 10, such as, for example, with vacuum cleaner bags, appliances, electronics equipment, and/or any product that may require a component that may need replacement. The connection of the front cover 25 with the back mounting shell 30 may provide an upper wall 57 above and/or a lower wall below the front cover 25. The upper wall 57 may extend above the U-shaped opening 51 so that the U-shaped opening 51 and the upper wall 57 surround the raised portion 22 of the cartridge 12. The lower wall 59 may extend below the front cover 25 and/or the cartridge 12 inserted into the U-shaped opening 51. The upper wall 57 above the front cover 25 and the lower wall 59 below the front cover 25, if connected to the back mounting shell 30, may maintain a position of the cartridge 12 within the U-shaped opening 51.

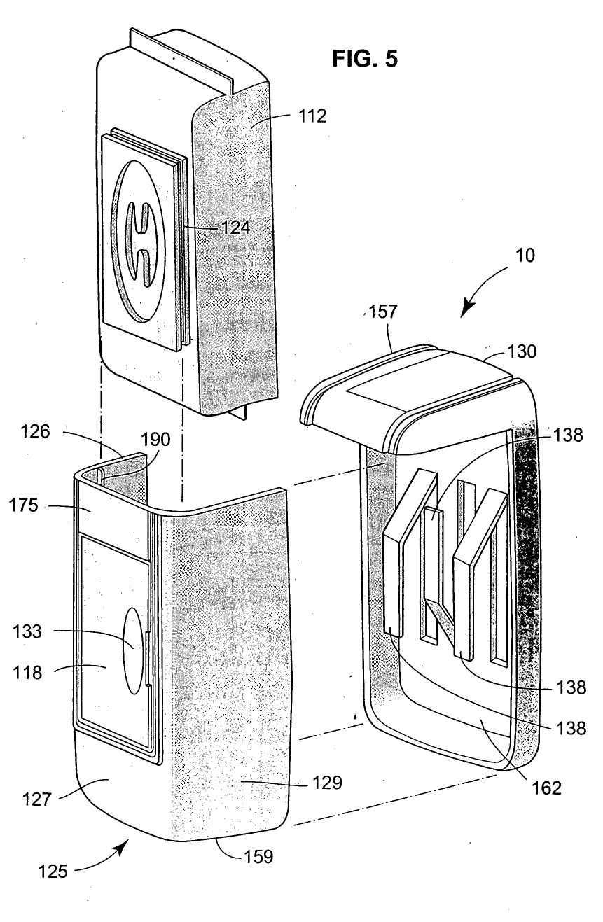

As generally illustrated in FIG. 5, a door 118 may be attached to the front piece 125 of the dispenser 10. Above the door 118 may be a window 175 that would reveal the indicia on a wipes cartridge 112 when inserted vertically into the dispenser 10. In this embodiment, the tracks 124 on the cartridge 112 may attach to grooves 190 in the front cover 25. In generally known dispensers, the door 118 may be attached to the dispenser so that replacement of the door requires replacement of the dispenser.

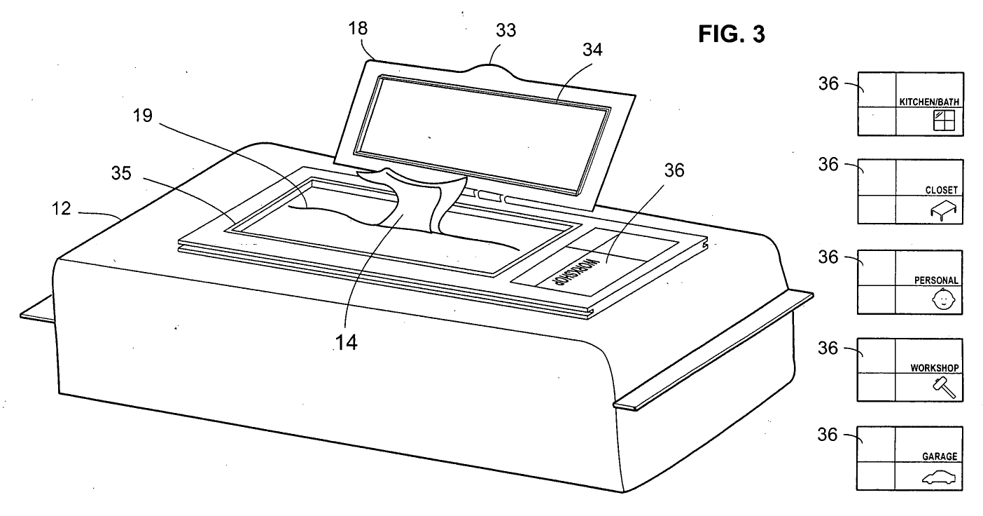

Attachment of the door 18 to the cartridge 12, as in the embodiment of the present invention generally illustrated in FIG. 2, may prevent a need to replace the door 18 since attachment of a new cartridge 12 to the front cover 25 provides a new door 18. Alternatively, the door 118 may be attached to the front cover 125, as generally illustrated in FIG. 5. The cartridge 112 may be attached to the front cover 125 so that the front cover 125 may connect to the back mounting shell 140 to form the wipes dispensing module 10. Referring again to FIGS. 2 and 3, the door 18 of the cartridge 12 may have a cap 33 that projects from the door 18 and may allow the user to open the door 18 using only one finger. The door 18 may be spring loaded so that if the cap 33 is pulled the door 18 may open to a position generally perpendicular to the front surface 27 of the front cover 25. Alternatively, as generally illustrated in FIG. 5, the door may be touch activated, where a finger is used to push in on the door 118 at the area indicated 133. A spring loading mechanism then is released to open the door 118 on the dispenser 10.

Referring again to FIGS. 2 and 3, if the door 18 is opened on the wipes dispensing module 10, the user may dispense one of the wipes 14 by pulling the leading end portion 20 of one of the wipes 14 through the opening 19 in the cartridge 12 and the U-shaped opening 51 in the front cover 25. As generally illustrated in FIG. 3, the door 18 on the cartridge 12 may have a molded male protrusion 34 that fits into a female silicon seal 35 positioned at the opening 19 over the wipes 14. The molded male protrusion 34 and the female silicon seal 35 may allow the wipes dispensing module 10 to utilize a new seal 35 for the door 18 each time that the cartridge 12 is replaced.

A label 36 may be designed on the cartridge 12 to be displayed through the U-shaped opening 51 of the front cover 25 if the cartridge 12 is connected to the front cover 25. Alternatively, the label 36 may be displayed through a window 175 above the door 118 of the wipes dispensing module 10, as generally illustrated in FIG. 5. The label 36 may provide identification of the intended use of the wipes 14 within the cartridge 12. The intended use of the wipes may be based on a formulated solution used to impregnate the wipes 14, a material used to manufacture the wipes 14 and/or a size and/or a shape of the wipes 14. The label 36 may use text, graphics, such as an icon, and/or color to convey the intended use of the wipe, a message and/or a sensation to the user. If the cartridge 12 is connected to the front cover 25, the front cover 25 may position the text, the graphics and/or the color printed on the cartridge 12 on the front of the wipes dispensing module 10 to make the intended use of the wipes identifiable.

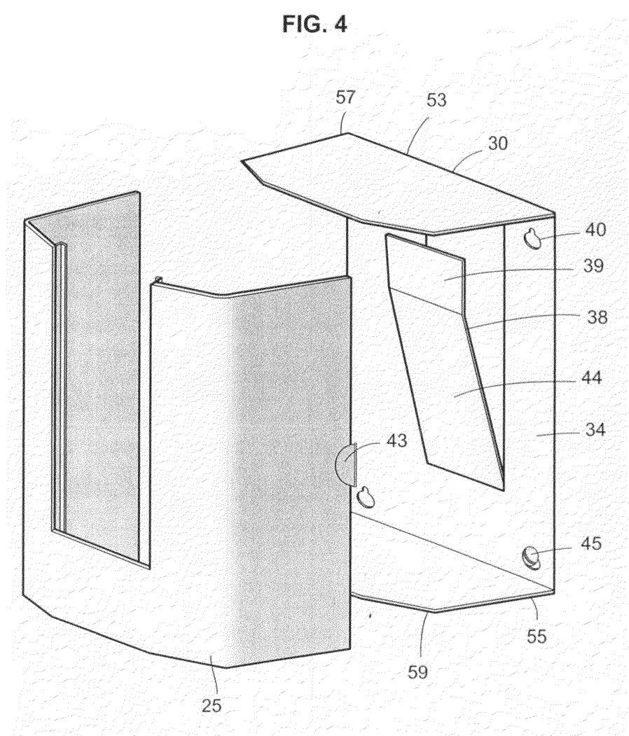

As generally illustrated in FIG. 4, the back mounting shell 30 may have a back surface 34. The back surface 34 may have an upper side 53, a lower side 55 that may be positioned opposite to the upper side 53, an upper wall 57 that may extend from the upper side 53 of the back surface 34 and a lower wall 59 that may extend from the lower side 55 of the back surface 34. The upper wall 57 and the lower wall 59 may be generally parallel. Alternatively, the upper wall 57 and the lower wall 59 may taper toward each other so that the upper wall 57 and the lower wall 59 are not generally parallel.

The front cover 25 may connect to the back mounting shell 30 via friction that may allow the front cover 25 to maintain attachment to the back mounting shell 30 and/or may allow the front cover 25 to be separated from the back mounting shell 30 for replacement of the cartridge 12. The connection of the front cover 25 to the back mounting shell 30 may form a box-like structure for the wipes dispensing module 10. The wipes dispensing module 10 may have a click tab 43 on a side of the wipes dispensing module 10 so that the click tab 43 may maintain the attachment of the front cover 25 to the back mounting shell 30 and/or may be pushed in to release the front cover 25 from connection with the back mounting shell 30. The front cover 25 and the back mounting shell 30 may connect together in a manner other than by friction or the click tab 43, such as by, for example, locking tabs, screws and/or other generally known interlocking means.

In the depicted embodiment of FIG. 2, the front cover 25 may provide the left wall 26 and/or the right wall 29, and the back mounting shell 30 may provide the top wall 57 and/or the lower wall 59. However, in an alternative embodiment, the front cover 25 may provide the upper wall 57 and/or the lower wall 59, and/or the back mounting shell 30 may provide the left wall 26 and/or the right wall 29. As generally shown in FIG. 5, the front cover 125 may provide the left wall 126, the right wall 129 and the lower wall 159, and the back mounting shell 130 may provide the upper wall 157. Further, the wipes dispensing module 10 may have a shape that is not rectangular and/or not box-like. As generally illustrated in FIG. 5, an the upper wall 157 may be attached to the back mounting shell 130, forming a seal above the wipes cartridge 112 if the front cover 125 and the back mounting shell 30 are connected.

The back mounting shell 30 of the wipes dispensing module 10 may have an angled plate 38 that extends from the back surface 34 of the back mounting shell 30 toward the front cover 25 to apply pressure to the back side 13 of the cartridge 12 and/or the wipes 14 within the cartridge 12 as generally illustrated in FIG. 4. The pressure applied by the angled plate 38 may position the wipes 14 within the cartridge 12 at the front side 15 of the cartridge 12, allowing access to the wipes 14. As the wipes 14 are used, the wipes 14 may sustain the position at the front side 15 of the cartridge 12 due to the pressure of the angled plate 38. The back mounting shell 130 may have a plurality of angled plates 138 as generally shown in FIG. 5.

The angled plate may have an end portion 39 that contacts the cartridge 12 and/or the wipes 14 within the cartridge 12. A connecting portion 44 of the angled plate 38 may attach the end portion 39 of the angled plate to the back mounting shell 30. Preferably, the end portion 39 may be rectangular so as to disperse pressure evenly upon the cartridge 12 and/or the wipes 14 within the cartridge 12. Alternatively, the angled plate 38 may be any form of projection from the back mounting shell 30 that exerts pressure on the cartridge 12 and/or the wipes 14 within the cartridge 12.

The angled plate 38 may be made from a material that is more flexible relative to a material of the dispensing module 10. The flexible material of the angled plate 38 may allow the end portion 39 of the angled plate 38 to be positioned adjacent to the back mounting shell 30 if the cartridge 12 is full of the wipes 14. Further, the flexible material of the angled plate 38 may allow the end portion 39 of the angled plate 38 to be positioned toward the U-shaped opening 51 of the front cover 25 if the wipes 14 are diminished in number.

As generally illustrated in FIG. 2, the cartridge 12 may have a base 60 within the back side 13 of the cartridge 12. The base 60 may be a piece of cardboard or plastic, for example. The wipes 14 may be positioned within the cartridge 12 on top of the base 60. The base 60 may provide rigidity to the back side 13 of the cartridge 12 if positioned vertically within the wipes dispensing module 10. If the cartridge 12 is positioned in the wipes dispensing module 10, the angled plate 38 may apply force against the back side 13 of the cartridge 12, pushing the base 60 against the wipes 14 to position the wipes 14 uniformly toward the opening 19 in the cartridge 12 so that the user may access the wipes 14. The angled plate 38 and/or the plurality of angled plates 138 may be located on a separate component 162 of the wipes dispensing module 10 to allow the user to replace and/or change the angle plate 38 and/or the plurality of angled plates 138. For example, differing wipes 14 of varying thickness may require different amounts of the force applied by the angled plate 38, and thus, the wipes dispensing system 10 may require different angled plates 38 based on the wipes 14 that may be used.

The back mounting shell 30 of the wipes dispensing module 10 may have mounting holes 40 to support screws 45 that connect the wipes dispensing module 10 to the wall and/or other like surface. Alternatively, or in conjunction with the screws 45, adhesive on the back mounting shell 30 may attach the wipes dispensing module 10 to the wall. If the back mounting shell 30 is connected to the wall, the front cover 25 and the cartridge 12 may be attached to the back mounting shell 30 to provide the wipes dispensing module 10 in a mounted position. Alternatively, the wipes dispensing module 10 may sit on a surface, such as, for example, a counter-top. The wipes dispensing module 10 may have rubber pads (not shown) attached to back mounting shell 30 and/or the lower wall 59 of the back mounting shell 30 to prevent movement of the wipes dispensing system 10.

Referring again to FIG. 1, additional wipes dispensing modules 10 may be stacked and/or aligned with the wipes dispensing module 10. The additional wipes dispensing modules 10 may be oriented so that the U-shaped opening 51 of the front cover 25 of the wipes dispensing module 10 faces a direction the same as a direction of the U-shaped openings 51 of the additional wipes dispensing modules 10. The additional wipes dispensing modules 10 may be positioned so that the U-shaped openings of the additional wipes dispensing modules 10 are adjacent. The additional wipes dispensing modules 10 may be utilized in conjunction with each other to provide wipes 14 of various intended functional utilities.

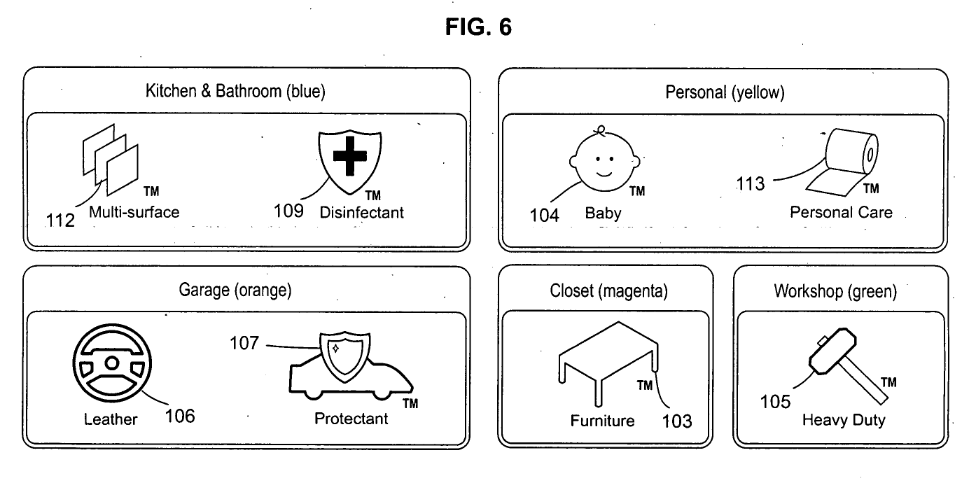

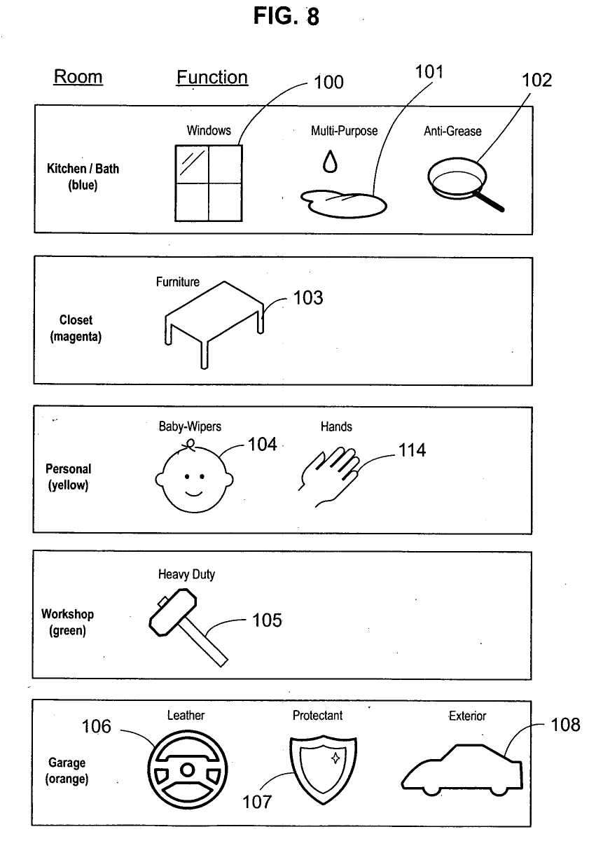

As generally illustrated in FIGS. 6-8, a color coded/icon method may be used to identify the intended use of the wipes. Each location within a residence, school, entertainment venue, restaurant or workplace may be given a color, for example, blue for a kitchen/bath, maroon for a closet, yellow for a baby and personal care in a bathroom, green for a workshop and/or orange for a garage. Thus, the color imprinted upon each of the wipes may indicate the location within the residence or workplace intended for use of the wipes. The location within the residence, the school, the entertainment venue, the restaurant or workplace intended for use of the wipes may correspond to the formulated solution impregnated into the wipes 14, the material used to manufacture the wipes 14 and/or the size and/or the shape of the wipes 14.

As generally illustrated in FIG. 6-8, each one of the wipes 14 may be given a functional icon printed directly on the wipes 14, such as, for example, a window symbol 100 for window cleaning, a depiction of a spill 101 for multi-purpose use, a greasy pan 102 for anti-grease use, a table 103 for a furniture polishing wipe, a baby face icon 104 for use upon a baby, a sledgehammer symbol 105 for heavy duty workshop use, a steering wheel 106 for leather car interior use, a shield 107 for a car protectant, a car shape 108 for car exterior cleaning, a cross on a shield 109 for disinfectant wipes, a stack of surfaces 112 for kitchen/bathroom multi-surface use, a roll of toilet paper 113 for personal hygiene wipes, a hand 114 for personal hand cleaning/antibacterial use, etc. The wipes 14 may be grouped according to the corresponding location of common use as associated by the color of the icon as discussed above; i.e. blue for windows in the kitchen/bath (windows, multipurpose, disinfectant), green for the workshop, orange for the garage, and so on. Thus, the color and/or the icon may differentiate each wipe 14 within the wipes dispensing system. The color and/or the icon may be imprinted upon the wipes 14 using an aqueous ink. Preferably, the ink may be printed on both sides of the substrate of the wipes 14.

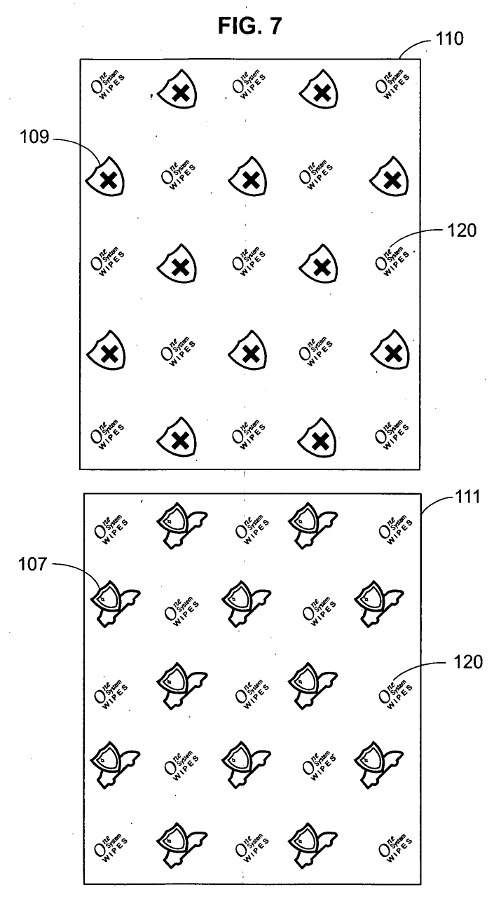

For example, as generally illustrated in FIG. 7, a first wipe 110 may have the cross on a shield icon 109. A second wipe 111 may have a car icon 107. The cross on a shield icon 109 and/or the car icon 107 may indicate that the first wipe 110 has a different intended use than the second wipe 111. Therefore, the first wipe 110 may be provided near the second wipe 111 without confusion as to the intended uses of the wipes 14. The first wipe 110 may be provided near the second wipe 11 by the wipes dispensing module 10 described above. The first wipe 110 may differ from the second wipe 111 in the formulated solution impregnated into the wipes 14, the material and/or method used to manufacture the wipes 14 and/or the size and/or the shape of the wipes 14. The first wipe 110 may have a different intended use than the second wipe 11 because of differences between the wipes, such as, for example, the solution, the fabric, the size and/or the shape. The user may discern the different intended uses based on the cross on a shield 109 and/or the shield on the car 107.

Further, fragrances may be incorporated into the wipes 14 so that each distinct scent may signal different functionality. A first fragrance associated with the first wipe 110 may distinguish the first wipe 110 from the second wipe 111 based on a second fragrance different than the first fragrance and associated with the second wipe 111. Association of one of the fragrances with one of the intended uses 14 may assist a visually impaired user in selecting and/or using the wipes.

The color, the text, the icon and/or the fragrance, all being indicia, may eliminate confusion as to the intended use of the wipe and, therefore, may solve a problem of utilizing the wipe for a wrong use. The color, the text, the icon and/or the fragrance may provide organization of the wipes in the house, the school, the entertainment venue, the restaurant and/or the workplace. In addition, the use of printing information directly on the wipe may serve as a communication tool for providing entertainment, education, aesthetics, sensation, organization and functionality, branding and advertising and/or consumer promotions to the user. For example, the branding and advertising may be accomplished by imprinting a brand logo 120 on the wipes.

The embodiments described above are not limited to pre-impregnated cleaning, polishing, disinfecting, antibacterial and protectant wipes for the household, workplace, utility area and for personal and pet care, but rather can be used to identify different intended uses of other items. It should be understood that various changes and modifications to the presently preferred embodiments described herein will be apparent to those skilled in the art. Such changes and modifications may be made without departing from the spirit and scope of the present invention and without diminishing its attendant advantages. It is, therefore, intended that such changes and modifications be covered by the appended claims.

I claim:

1. A disposable wipe comprising:
a substrate made from an absorbent textile material wherein the substrate has a top side and a bottom side wherein the bottom side is positioned opposite to the top side;
a formulated utility solution impregnated into the substrate; and
colored graphic indicia imprinted in aqueous ink to the top side of the substrate and the bottom side of the substrate that indicates the formulated utility solution impregnated into the substrate.

2. The disposable wipe of claim 1 wherein the absorbent textile material is a non-woven material.

3. The disposable wipe of claim 1 further comprising:
a fragrance applied to the substrate wherein the fragrance is a representation of an intended use of the formulated utility solution.

4. The disposable wipe of claim 1 wherein the colored graphic indicia are representations of an intended use of the formulated utility solution.

5. The disposable wipe of claim 1 wherein the colored graphic indicia denote a location where the substrate is intended to be commonly used.

6. The disposable wipe of claim 1 wherein the colored graphic indicia are brand logos that correspond to a manufacturer of the substrate.

7. A system for providing pre-impregnated cleaning, disinfecting, antibacterial, polishing, protectant wipes wherein the wipes are impregnated for any one of a plurality of intended uses, the system comprising:
a formulated solution having one of the plurality of intended uses;
a first set of substrates wherein the formulated solution is impregnated into each of the set of substrates wherein each of the first set of substrates has a first side and a second side wherein the second side is positioned opposite to the first side; and
colored indicia imprinted in aqueous ink on the first side and the second side of each of the first set of substrates wherein the colored indicia indicate one of the plurality of intended uses of the formulated solution.

8. The system of claim 7 wherein the colored indicia denote a location where the first set of substrates is intended to be commonly used.

9. The system of claim 7 wherein the colored indicia indicate a shape of each of the first set of substrates.

10. The system of claim 7 wherein the colored indicia indicate a size of each of the first set of substrates.

11. The system of claim 7 further comprising:
a fragrance associated with the first set of substrates wherein the fragrance corresponds to one of the plurality of intended uses of the set of substrates.

12. The system of claim 7 wherein the first set of substrates are made from absorbent material.

13. The system of claim 7 wherein the first set of substrates are made from paper material.

14. The system of claim 7 further comprising:
a second set of the substrates wherein colored indicia are imprinted in aqueous ink on the second set of substrates wherein the colored indicia imprinted on the second set of substrates are different than the colored indicia imprinted on the first set of substrates.

15. A method for providing wipes, the method comprising the steps of:
providing a first set of substrates wherein the first set of substrates has a function;
applying a formulated solution to the first set of substrates to effectuate the function of the first set of substrates; and
imprinting colored indicia in aqueous ink on a top side and a back side of each of the first set of substrates wherein the back side is positioned opposite to the top side wherein the colored indicia identify the function of the first set of substrates.

16. The method of claim 15 wherein the colored indicia indicate a location where the first set of substrates is intended to be commonly used.

17. The method of claim 15 wherein the colored indicia are representations of an intended use of the formulated solution.

18. The method of claim 15 further comprising the step of:
associating a fragrance with the first set of substrates wherein the fragrance indicates the function of the first set of substrates.

19. The method of claim 15 further comprising the step of:
providing a second set of substrates wherein colored indicia are imprinted on the second set of substrates wherein the colored indicia printed on the second set of substrates are different than the colored indicia printed on the first set of substrates wherein the colored indicia printed on the second set of substrates identify a function of the second set of substrates wherein the function of the first set of substrates is different than the function of the second set of substrates.

20. The method of claim 15 wherein the colored indicia indicate a size of the wipe.

21. The method of claim 15 wherein the colored indicia indicate a shape of the wipe.
